(19) United States
(12) Patent Application Publication
(10) Pub. No.: US 2022/0209820 A1
(43) Pub. Date: Jun. 30, 2022

(54) SYSTEMS CONFIGURED TO DELIVER POWER VIA INDOOR NETWORK INFRASTRUCTURE, AND RELATED METHODS AND APPARATUSES

(71) Applicant: CommScope Technologies LLC, Hickory, NC (US)

(72) Inventors: John C. Chamberlain, Hickory, NC (US); Trevor D. Smith, Eden Prairie, MN (US); Morgan C. Kurk, Denver, NC (US)

(21) Appl. No.: 17/601,847

(22) PCT Filed: Mar. 18, 2020
(86) PCT No.: PCT/US2020/023272

§ 371 Date: Oct. 6, 2021

Related U.S. Application Data
(60) Provisional application No. 62/833,907, filed on Apr. 15, 2019.

(51) Int. Cl. H04B 3/54

(52) U.S. Cl. CPC H04B 3/54; H04L 12/10

(57) ABSTRACT

Systems that are configured to deliver electric power via an indoor telecommunications network infrastructure are provided herein. A system may include a power adaptor that is inside a building and that is electrically connected to an indoor telecommunications network infrastructure that is inside the building. Moreover, the system may include an outdoor network interface apparatus that is outside of the building and that is configured to receive electric power via a wired connection to the indoor telecommunications network infrastructure. Related methods and apparatuses are also provided.

### CROSS-REFERENCE TO RELATED APPLICATION

The present application claims priority to U.S. Provisional Patent Application No. 62/833,907, filed Apr. 15, 2019, the entire content of which is incorporated herein by reference.

### FIELD

The present disclosure relates to communication systems and, in particular, to power delivery for communications systems.

### BACKGROUND

In many information and communication technology systems, network-connected electronic devices are deployed in locations where a local electric power source is not available. With the proliferation of the Internet of Things (IoT), autonomous driving, fifth generation (5G) cellular service, and the like, it is anticipated that network-connected electronic devices will increasingly be deployed at locations that lack a conventional electric power source.

Electric power may be provided to such remote network-connected electronic devices in numerous ways. For example, a local electric utility company can install a connection to the electric power grid. This approach, however, is typically both expensive and time-consuming, and unsuitable for many applications. Composite power-data cables can also be used to power remote network-connected electronic devices and provide data connectivity thereto over a single cabling connection. Composite power-data cables refer to cables that can transmit both electric power and data. Power-over Ethernet (PoE) cables are one type of composite power-data cable. PoE technology, however, has limitations in terms of both data communication throughput and the amount of power delivered, and these limitations become more restrictive with increased distance between the remote network-connected electronic device and the PoE source. For example, under current PoE standards, high throughput data communications may only be supported for cable lengths of up to about 100 meters, and even at these short distances the power delivery capacity is only about 100 Watts. Power-plus-fiber cables are another example of a type of composite power-data cable that includes both power conductors and optical fibers within a common cable jacket. Power-plus-fiber cables, however, can be prohibitively expensive to install for many applications. Other known types of composite power-data cables include coaxial cables, telephone twisted-pair cables with remote power feeding on some pairs and Digital Subscriber Line (DSL) data on other pairs or with both power and DSL on the same pairs, and composite cables having larger conductors (e.g., 10-12 AWG) for power transmission and smaller gauge twisted pairs for data transmission.

### SUMMARY

A system that is configured to deliver electric power via an indoor telecommunications network infrastructure that is inside a building, according to some embodiments herein, may include a power adaptor that is inside the building and is electrically connected to the indoor telecommunications network infrastructure. The system may include an outdoor network interface apparatus that is outside of the building and that is configured to receive input electric power via a wired connection to the indoor telecommunications network infrastructure. Moreover, the system may include telecommunications network equipment that is outside of the building and outside of the outdoor network interface apparatus. The outdoor network interface apparatus may be further configured to provide output electric power to the telecommunications network equipment.

In some embodiments, the outdoor network interface apparatus may be further configured to receive data via the wired connection or via another wired connection to the indoor telecommunications network infrastructure.

According to some embodiments, the outdoor network interface apparatus may be an outdoor Network Interface Device (NID). Additionally or alternatively, the outdoor network interface apparatus may include power electronics circuitry that is configured to receive the input electric power via the wired connection. The wired connection may be a first wired connection, and the telecommunications network equipment may be wireless network equipment. Moreover, the power electronics circuitry may be further configured to provide the output electric power to the wireless network equipment via a second wired connection, based on the input electric power, which may be different from the output electric power. The indoor telecommunications network infrastructure may, in some embodiments, include preexisting telephone, computer-network, or coaxial wiring, or preexisting optical fiber, that is inside the building, and the wireless network equipment may be a fixed wireless node.

In some embodiments, the power adaptor may be: plugged into an electrical power outlet that is inside the building; and connected to a jack of the indoor telecommunications network infrastructure.

An outdoor network interface apparatus, according to some embodiments herein, may be configured to receive input electric power via a wired connection to an indoor telecommunications network infrastructure that is inside a building, and to provide output electric power to telecommunications network equipment that is outside of the building and outside of the outdoor network interface apparatus.

In some embodiments, the outdoor network interface apparatus may be further configured to receive data via the wired connection or via another wired connection to the indoor telecommunications network infrastructure. Additionally or alternatively, the outdoor network interface apparatus may be an outdoor Network Interface Device (NID).

According to some embodiments, the outdoor network interface apparatus may include power-conversion circuitry that is configured to: receive the input electric power via the wired connection, which may be a first wired connection; convert the input electric power into the output electric power, which may be different from the input electric power; and provide the output electric power to the telecommunications network equipment via a second wired connection.

In some embodiments, the wired connection may be a first electrical connection to a first physical communications medium of the indoor telecommunications network infrastructure. Moreover, the outdoor network interface apparatus may include a second electrical connection to a second physical communications medium of the indoor telecommunications network infrastructure. The first electrical connection may include a first cable jack, cable port, or wire terminal, and the second electrical connection may include a second cable jack, cable port, or wire terminal. Additionally or alternatively, the outdoor network interface apparatus may include power-conversion circuitry that is electrically connected to the first electrical connection, the second electrical connection, or both the first electrical connection and the second electrical connection.

According to some embodiments, the telecommunications network equipment may be wireless network equipment that is configured to provide wireless communications service into the building. Moreover, the outdoor network interface apparatus may include power electronics circuitry that is configured to provide the output electric power to the wireless network equipment based on the input electric power.

In some embodiments, the indoor telecommunications network infrastructure may include preexisting telephone, computer-network, or coaxial wiring, or preexisting optical fiber, that is inside the building and that is electrically connected to a power converter that is inside the building.

A method of delivering electric power via an indoor telecommunications network infrastructure that is inside a building, according to some embodiments herein, may include receiving input electric power at an outdoor network interface apparatus that is outside of the building via a wired connection to the indoor telecommunications network infrastructure. Moreover, the method may include providing output electric power to telecommunications network equipment that is outside of the building and outside of the outdoor network interface apparatus, based on the input electric power.

In some embodiments, the method may include receiving, via the wired connection or via another wired connection to the indoor telecommunications network infrastructure, data at the outdoor network interface apparatus. Additionally or alternatively, the method may include transmitting a signal from the outdoor network interface apparatus to the indoor telecommunications network infrastructure, to request the input electric power. Moreover, the method may include providing the input electric power to the indoor telecommunications network infrastructure via a power adaptor that is inside the building.

### BRIEF DESCRIPTION OF THE DRAWINGS

FIG. 1 is a schematic diagram illustrating the increasing power and data connectivity needs for information and communication technology infrastructure in high density access networks.

FIG. 2A is a schematic block diagram of a system, according to embodiments of the present inventive concepts, that is configured to deliver electric power via indoor telecommunications network infrastructure that is inside a building to an outdoor network interface apparatus that is outside of the building.

FIG. 2B is a block diagram of the outdoor network interface apparatus of FIG. 2A.

FIG. 2C is a block diagram of the indoor telecommunications network infrastructure of FIG. 2A.

FIG. 3A is a front view of an outdoor network interface apparatus according to embodiments of the present inventive concepts.

FIG. 3B is an enlarged view of an electrical connection that is inside the outdoor network interface apparatus of FIG. 3A.

FIGS. 4A and 4B are flowcharts of operations of power delivery according to embodiments of the present inventive concepts.

FIG. 5 is a block diagram of an example processor and memory according to embodiments of the present inventive concepts.

### DETAILED DESCRIPTION

Pursuant to embodiments of the present inventive concepts, systems for delivering electric power and/or data via indoor telecommunications network infrastructure are provided, along with related methods and apparatuses. It may be desirable to provide electric power and/or data from inside a customer premise (e.g., a home or other building) to telecommunications (e.g., wireless) network equipment that is near, but outside of, the customer premise. It may be difficult, however, for a technician to schedule access to the inside of the customer premise, and such internal access may inconvenience the customer. Thus, to cost-effectively and time-independently (i.e., independently of the customer's schedule) install, for example, outdoor fixed wireless service or outdoor Gigabit Passive Optical Network (GPON) service at the customer premise, there should be no requirement for entrance inside the customer premise.

Embodiments of the present inventive concepts use preexisting or newly-installed indoor (i.e., internal/interior) wiring for the purpose of delivering power from the inside of the customer premise to the outside and/or facilitating data connectivity. A power adaptor (e.g., converter/transformer) may be used in a standard interior power outlet to impart power onto an indoor wiring system within local code restrictions for voltage, amperage, and wattage. Electrical connection to the indoor wiring system may be accomplished via any of various connectors. For example, RJ11 jacks or screw terminals may be used for telephone wiring, RJ45 jacks may be used for Ethernet computer-network wiring, an F-connector may be used for coaxial wiring, and so on.

Most indoor wiring systems, whether new or preexisting/abandoned, include an interface to the outside of a building. This interface is typically a Network Interface Device (NID), which may comprise an enclosure on the outside of the building. The enclosure may be a plastic enclosure, a metal enclosure, or another type of enclosure. Conventionally, the NID lacks a connection to electric power from inside the building. According to embodiments of the present inventive concepts, however, a power adaptor and associated cabling and connectors may be sent (e.g., mailed/shipped) to a customer for self-installation inside the building to serve the NID. After the customer's self-installation, a fixed wireless operator (or other telecommunications service provider) may perform an outside installation of telecommunications network equipment by electrically connecting the outdoor equipment to the NID that is served by the power adaptor, thus allowing for installation of the outdoor equipment without entry by the installer inside the building.

The delivery of electric power and/or data from inside the building to equipment that is outside of the building may be referred to as “reverse power feeding,” or simply as “reverse-feeding.” Examples of reverse power feeding over twisted-pair wiring are discussed in the technical specification ETSI TS 101 548-1 V2.2.1 (2018-06), which is incorporated herein in its entirety by reference. The ETSI technical specification discusses, for example, power insertion at a customer premise and power extraction by a remote node. Moreover, data communication can be performed using, for example, G.fast transmission (ITU-T G.9700 & G.9701) over one twisted-pair or over coaxial wiring. As another example, Gigabit Ethernet can be combined with PoE on a Category 5 or Category 6 cable.

Embodiments of the present inventive concepts can reverse-feed electric power from the building to, for example, an access point that is used by a television provider (or other telecommunications service provider) outside of the building. Moreover, this reverse power feeding may be performed even if the network infrastructure (e.g., wiring) that is used inside the building for the reverse-feeding is not abandoned (i.e., is used for its original intended telecommunications purpose). In some embodiments, if the network infrastructure is abandoned, then it may be used to reverse-feed both (a) electric power and (b) data to the access point.

Example embodiments of the present inventive concepts will be described in greater detail with reference to the attached figures.

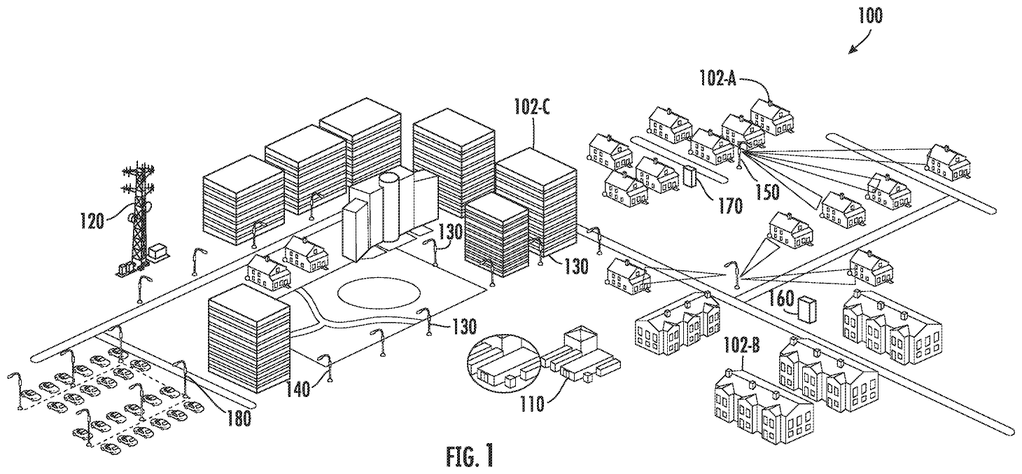

FIG. 1 is a schematic diagram illustrating the increasing power and data connectivity needs for information and communication technology infrastructure in high density access networks. As shown in FIG. 1, in an urban or suburban environment 100, a telecommunications provider, such as a cellular network operator, may operate a central office 110 and a macrocell base station 120. In addition, the telecommunications provider may operate a plurality of small cell base stations 130, WiFi access points 140, fixed wireless nodes 150, active cabinets 160, DSL (e.g., G.fast) distribution points 170, security cameras 180, and the like. All of these installations may require Direct Current (DC) power to operate active equipment, and most, if not all, of these installations may also require data connectivity either for backhaul connections to the central office 110 and/or for control or monitoring purposes. It may be both expensive and time consuming to provide local power sources for these installations.

To reduce costs and increase the speed at which electric power and data connectivity can be deployed to remote network-connected powered devices such as the remote devices 130, 140, 150, 160, 170, 180 illustrated in FIG. 1, the use of power-plus-fiber cables has been proposed. For example, PCT Publication No. WO 2018/017544 A1, which is incorporated herein in its entirety by reference, discloses an approach for providing power and data connectivity to a series of remote powered devices in which power-plus-fiber cables extend from a power source to a plurality of intelligent remote distribution nodes. Each intelligent remote distribution node may include a “pass-through” port so that the remote distribution nodes may be coupled to the power source in “daisy chain” fashion. Intelligent remote powered devices may be connected to each intelligent remote distribution node and may receive power and data connectivity from the intelligent remote distribution node.

One drawback of the approach disclosed in PCT Publication No. WO 2018/017544 A1 is that as new installations are deployed, it is necessary to install another power-plus-fiber cable that runs from the power source to the new installation. Deploying such power-plus-fiber cables can be time consuming and expensive, particularly in urban environments.

According to U.S. Patent Application No. 62/700,350, which is incorporated herein in its entirety by reference, the power source equipment and remote distribution node approach disclosed in PCT Publication No. WO 2018/017544 A1 may be extended so that cellular network operators may create a hard wired power and data connectivity micro grid throughout high density urban and suburban areas. As new installations (e.g., new small cell base stations 130, security cameras 180, and the like) are deployed in such areas, the cellular network operator may simply tap into a nearby portion of the micro grid to obtain power and data connectivity without any need to run cabling connections all the way from the power and data source equipment to the new installation. The micro grids may be viewed as being akin to the backplane on a computer, as the micro grids extend throughout the area in which power and data connectivity are required and have excess power and data connectivity resources available so that new installations may simply “plug into” the micro grid at any of a large number of tap points.

FIG. 1 also illustrates a plurality of buildings 102, including single-family houses 102-A, multi-unit commercial and/or residential buildings 102-B, and office buildings 102-C. According to embodiments of the present inventive concepts, indoor wiring of a building 102 can be used to provide electric power and/or data to network equipment that is outside of the building 102.

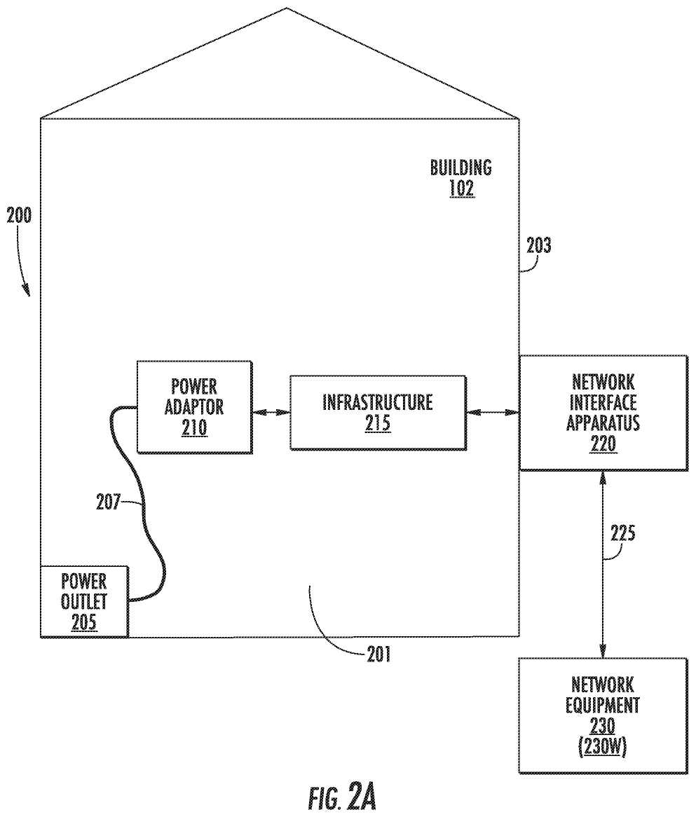

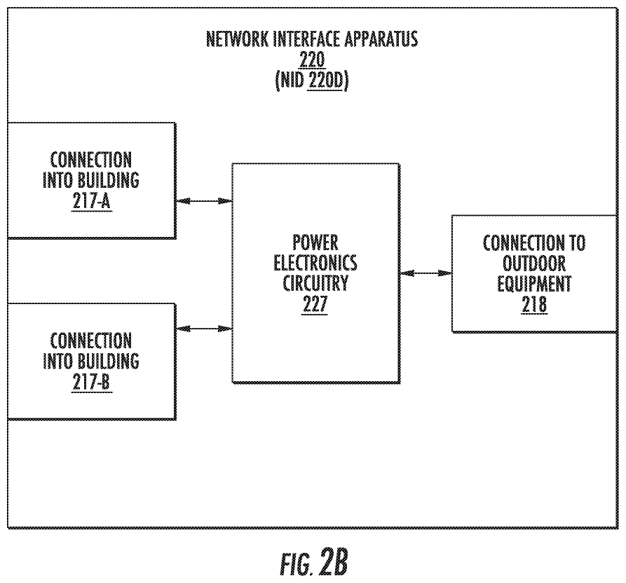

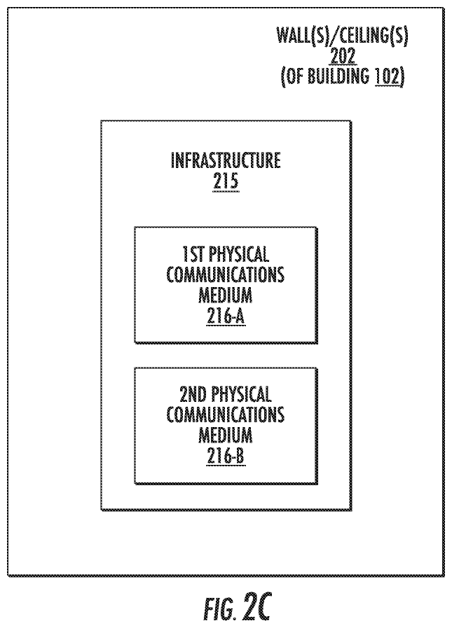

FIG. 2A is a schematic block diagram of a system 200, according to embodiments of the present inventive concepts, that is configured to deliver electric power via indoor telecommunications network infrastructure 215 that is inside a building 102 to an outdoor Network Interface Apparatus (NIA) 220 that is outside of the building 102. As used herein with respect to the building 102, the terms “indoor” and “inside” may refer to any interior region 201 of the building 102.

The interior region 201 is separated from the outdoor NIA 220 by an exterior surface 203 of the building 102. The exterior surface 203 comprises one or more materials exposed to outdoor elements, including materials such as brick, stone, concrete, stucco, vinyl siding, wood siding, and/or glass. The term “outdoor,” as used herein, refers to an apparatus that is not inside the building 102. For example, the outdoor NIA 220 may be on or adjacent the exterior surface 203.

In some embodiments, the outdoor NIA 220 may be electrically connected to outdoor telecommunications network equipment 230 (e.g., outdoor wireless network equipment 230W), which may comprise one or more of the remote devices 130, 140, 150, 160, 170, 180 (FIG. 1) or other electronic devices that provide, or are connected to, a telecommunications service. As an example, the outdoor NIA 220 may be configured to provide electric power to the outdoor equipment 230 via a wired connection 225, which may comprise a power cord and/or other wiring (e.g., a coaxial cable or other composite power-data cable). In particular, the outdoor NIA 220 may receive electric power from inside the building 102 via a wired connection to the indoor infrastructure 215 and then may deliver electric power to the outdoor equipment 230, which is outside of the outdoor NIA 220, via the wired connection 225. In some embodiments, the outdoor equipment 230 may also receive and/or transmit data via the wired connection 225. As used herein, the term “wired connection” may refer to wiring and/or one or more connectors for the wiring.

Inside the building 102, the indoor infrastructure 215 comprises one or more physical communications media 216 (FIG. 2C), such as optical fiber, coaxial wiring, computer-network wiring, and/or telephone wiring. The term “wiring,” as used herein, may refer to wires or optical fiber in one or more cables, as well as associated connectors. A portion of one or more of the media 216 extends from inside the building 102 into the outdoor NIA 220, thus providing at least one wired connection of the outdoor NIA 220 into the building 102. In addition to the media 216, the indoor infrastructure 215 may, in some embodiments, include one or more routers, access points, gateways, switches, modems, repeaters, filters, or other communications network devices.

In some embodiments, a power adaptor 210 is also inside the building 102 and is electrically connected to the indoor infrastructure 215. In particular, the power adaptor 210 may be configured to provide (e.g., insert) electric power to the indoor infrastructure 215. This enables the outdoor NIA 220, which is electrically connected to the indoor infrastructure 215, to deliver electric power to the outdoor equipment 230, which may otherwise lack a power source.

The power adaptor 210 may provide electric power when it is plugged into an electrical power outlet 205 of the building 102. For example, the outlet 205 may be in the same room inside the building 102 as an outlet for the indoor infrastructure 215. The power adaptor 210 may thus have both a wired electrical connection 207 to the outlet 205 and a wired electrical connection to the indoor infrastructure 215. For example, the power adaptor 210 may comprise one or more connectors, such as cable jacks, cable ports, or wire terminals, for the indoor infrastructure 215.

The power adaptor 210 may comprise power-conversion circuitry/equipment and/or power-insertion circuitry/equipment. In some embodiments, the power adaptor 210 may further comprise data-extraction-and-insertion circuitry/equipment that is configured to transmit and receive data via the indoor infrastructure 215. Alternatively, a separate adaptor inside the building 102 may comprise the data-extraction-and-insertion circuitry/equipment. Accordingly, the system 200 may comprise the power adaptor 210, a data adaptor, the indoor infrastructure 215, the outdoor NIA 220, the wired connection 225, and/or the outdoor equipment 230.

FIG. 2B is a block diagram of the outdoor NIA 220 of FIG. 2A. As shown in FIG. 2B, the outdoor NIA 220 may include at least one electrical connection 217 into the building 102 (FIG. 2A), as well as an electrical connection 218 to the outdoor equipment 230 (FIG. 2A).

For example, the connection(s) 217 may include a first electrical connection 217-A and a second electrical connection 217-B, each of which may comprise one or more connectors, such as cable jacks, cable ports, or wire terminals, for the indoor infrastructure 215 (FIG. 2A). As an example, the first connection 217-A may comprise a coaxial wiring connector or an optical fiber connector, and the second connection 217-B may comprise a telephone wiring connector or a computer-network wiring connector. Accordingly, the connection(s) 217 can facilitate one or more wired connections of the outdoor NIA 220 to the indoor infrastructure 215.

Moreover, the connection 218 may comprise a connector, such as a power-cord port and/or a coaxial connector, for the wired connection 225 (FIG. 2A). In some embodiments, the connection 218 may be electrically connected to power electronics circuitry 227. The connection(s) 217 may also be electrically connected to the power electronics circuitry 227, which may comprise, for example, power-conversion circuitry that is configured to convert between Alternating Current (AC) and DC and/or to change the voltage and/or frequency of electric power that is input to the power electronics circuitry 227 via the connection(s) 217. Accordingly, the outdoor NIA 220 can output electric power via the connection 218 based on (e.g., converted from) electric power that is input via the connection(s) 217. In some embodiments, the output electric power is different (e.g., DC vs. AC, different voltage, and/or different frequency) from the input electric power.

Though FIG. 2B illustrates a single connection 218, the power electronics circuitry 227 may, in some embodiments, be electrically connected to a plurality of outdoor telecommunications network equipment 230 via respective connections 218. The power electronics circuitry 227 may use the plurality of connections 218 to deliver different respective power levels, depending on the power requirements of different outdoor equipment 230.

In some embodiments, the outdoor NIA 220 may be, or may be included in, an outdoor NID 220D, which is sometimes also referred to in the telecommunications industry as a “network interface unit,” a “telephone network interface,” a “system network interface,” a “telephone network box,” or a “network termination device.” The outdoor NID 220D provides demarcation between (a) a telecommunications carrier's wiring and equipment and (b) a telecommunications customer's wiring and equipment. For example, the outdoor NID 220D may comprise a small, weather-resistant box that is mounted on the outside of the customer's building 102 (FIG. 2A). The carrier typically owns the outdoor NID 220D and outdoor wiring leading up to the outdoor NID 220D. Any equipment or wiring past the outdoor NID 220D (i.e., in, or leading into, the customer's building 102) is typically the responsibility of the customer rather than the carrier.

FIG. 2C is a block diagram of the indoor infrastructure 215 of FIG. 2A. As shown in FIG. 2C, the indoor infrastructure 215 may comprise at least one physical communications medium 216. For example, the media 216 may include a first physical communications medium 216-A and a second physical communications medium 216-B, each of which may comprise wiring, such as coaxial wiring, computer-network wiring, telephone wiring, or optical fiber. As an example, the first medium 216-A may be a coaxial cable or an optical fiber cable, and the second medium 216-B may be a telephone cable or a computer-network cable.

A portion of the first medium 216-A may extend from inside the building 102 (FIG. 2A) to a first electrical connection 217-A (FIG. 2B) of the outdoor NIA 220, and a portion of the second medium 216-B may extend from inside the building 102 to a second electrical connection 217-B (FIG. 2B) of the outdoor NIA 220. Accordingly, the first and second media 216-A and 216-B can facilitate first and second wired connections, respectively, of the outdoor NIA 220 into the building 102.

In some embodiments, the indoor infrastructure 215 may be inside one or more walls and/or ceilings 202 of the building 102. Moreover, the first medium 216-A and/or the second medium 216-B may be installed inside the building 102 before the power adaptor 210 (FIG. 2A) is sent to the customer, and thus may be referred to herein as “preexisting” wiring. For example, the indoor infrastructure 215 may have been installed before the advent of 5G cellular mobile communications technology. In particular, the first medium 216-A and/or the second medium 216-B may be part of an abandoned/unused communications network, such as telephone, television, and/or computer-network wiring that the customer no longer uses, or never used, for its original intended purpose. Some embodiments may thus replace (a) the previous intended use of a communications network that is already deployed within the building 102 with (b) power delivery from inside the building 102 to outside the building 102. Moreover, some embodiments may continue using the first medium 216-A and/or the second medium 216-B for data communications, and may supplement such data communications use with the further use of power delivery via the first medium 216-A and/or the second medium 216-B.

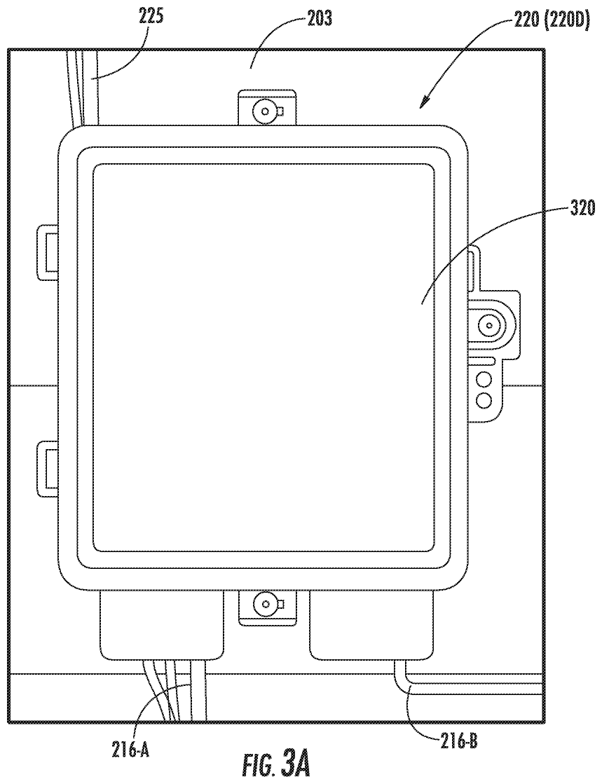

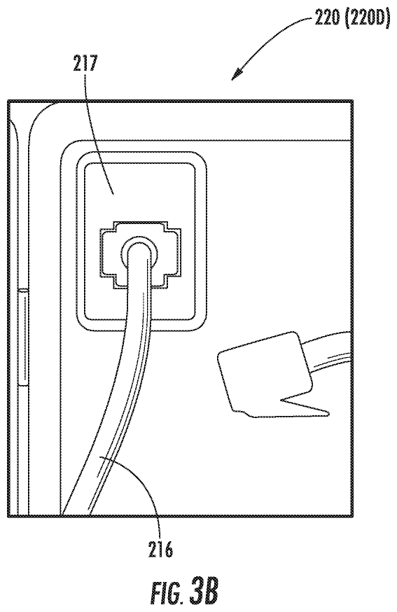

FIG. 3A is a front view of an outdoor NIA 220 according to embodiments of the present inventive concepts. As shown in FIG. 3A, a portion of a first physical communications medium 216-A and a portion of a second physical communications medium 216-B extend from inside a building 102 (FIG. 2A) to electrically connect to the outdoor NIA 220. The first medium 216-A and the second medium 216-B may be different first and second types (e.g., coaxial vs. telephone) of wiring, respectively. Other wiring (e.g., computer-network wiring and/or optical fiber) may also extend from inside the building 102 to electrically connect to the outdoor NIA 220. A wired connection 225 may extend from the outdoor NIA 220 to outdoor wireless network equipment 230W (FIG. 2A) or other outdoor telecommunications network equipment 230 (FIG. 2A).

In some embodiments, the outdoor NIA 220 may be attached (e.g., mounted with screws or other fasteners) to an exterior surface 203 of the building 102 (FIG. 2A). Moreover, the outdoor NIA 220 may comprise an enclosure/cover 320 that protects power electronics circuitry 227 (FIG. 2B) and electrical connections 217 and 218 (FIG. 2B) of the outdoor NIA 220 from dust, dirt, precipitation, moisture, and the like.

FIG. 3B is an enlarged view of an electrical connection 217 that is inside the outdoor NIA 220 of FIG. 3A. As shown in FIG. 3B, the electrical connection 217 may comprise a connector, such as a cable jack, for a physical communications medium 216.

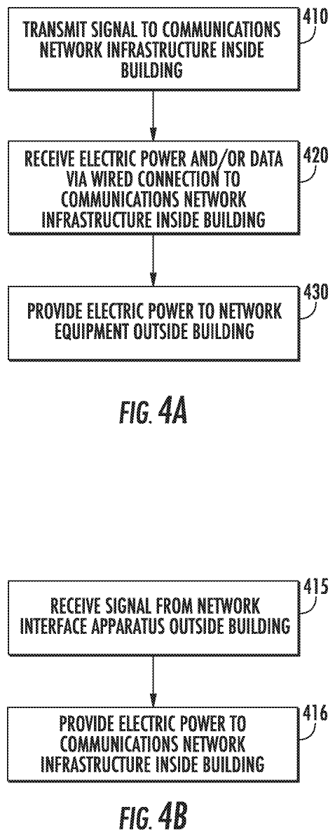

FIGS. 4A and 4B are flowcharts of operations of power delivery according to embodiments of the present inventive concepts. As shown in FIG. 4A, operations of delivering electric power via indoor telecommunications network infrastructure 215 (FIG. 2A) that is inside a building 102 (FIG. 2A) may include receiving (Block 420) input electric power at an outdoor NIA 220 (FIG. 2A) that is outside of the building 102 via a wired connection 217 (FIG. 2B) to the indoor infrastructure 215. Moreover, the operations may include providing (Block 430) output electric power from the outdoor NIA 220 to telecommunications network equipment 230 (FIG. 2A) that is outside of the building 102, based on the input electric power.

In some embodiments, the outdoor NIA 220 may also receive (Block 420) data via the wired connection 217 or via another wired connection 217 to the indoor infrastructure 215. For example, the operations of Block 420 may include concurrently or sequentially receiving data and electric power via the same wired connection 217, or via different respective wired connections 217.

Additionally or alternatively, the outdoor NIA 220 may transmit (Block 410) a signal to the indoor infrastructure 215. For example, the outdoor NIA 220 may transmit, via the indoor infrastructure 215, a request/command for data and/or electric power to a power adaptor 210 (FIG. 2A) that is inside the building 102, and may then receive (Block 420) data and/or electric power via the indoor infrastructure 215. The data and/or electric power may be received (Block 420) via the same physical communications medium 216 (FIG. 2C) by which the signal is transmitted (Block 410), or via a different medium 216.

Referring to FIG. 4B, the power adaptor 210 may perform power delivery operations comprising providing (Block 416) electric power to the indoor infrastructure 215. In some embodiments, the power adaptor 210 may also receive (Block 415), via the indoor infrastructure 215, a signal from the outdoor NIA 220, and then may responsively provide (Block 416) electric power to the outdoor NIA 220 via the indoor infrastructure 215. The received signal may be the signal that is transmitted (Block 410) in FIG. 4A. Moreover, in addition to providing (Block 416) electric power, the power adaptor 210 may provide data to the outdoor NIA 220 via the indoor infrastructure 215. The data may include, for example, details (e.g., voltage, wattage, and the like) about the electric power that the power adaptor 210 delivers.

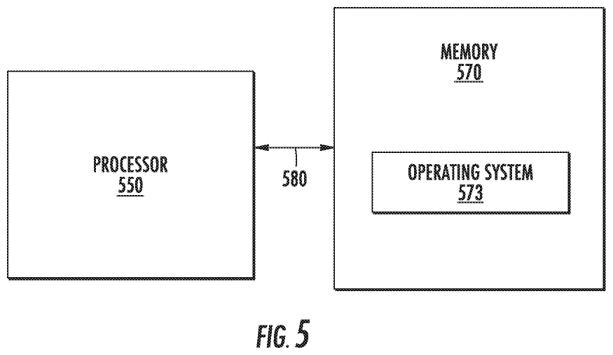

FIG. 5 illustrates a block diagram of an example processor 550 and memory 570 that may be used in accordance with embodiments of the present inventive concepts. The processor 550 communicates with the memory 570 via an address/data bus 580. The processor 550 may be, for example, a commercially available or custom microprocessor. Moreover, the processor 550 may include multiple processors. The memory 570 is representative of the overall hierarchy of memory devices containing the software and data used to implement various functions as described herein. The memory 570 may include, but is not limited to, the following types of devices: cache, ROM, PROM, EPROM, EEPROM, flash, Static RAM (SRAM), and Dynamic RAM (DRAM).

As shown in FIG. 5, the memory 570 may hold various categories of software and data, such as an operating system 573. The operating system 573 can control operations of power electronics circuitry 227 (FIG. 2B) or a power adaptor 210 (FIG. 2A). In particular, the operating system 573 may manage resources of the power electronics circuitry 227 or the power adaptor 210 and may coordinate execution of various programs by the processor 550. Accordingly, an outdoor NIA 220 (FIG. 2A) may comprise, and may use, a processor 550 and a memory 570 to perform one or more of the operations shown in FIG. 4A.

For example, the processor 550 and the memory 570 may control the power electronics circuitry 227 to perform one or more of the operations shown in FIG. 4A. The processor 550 and the memory 570 may be a part of a box/module that includes the power electronics circuitry 227, or may be in a separate box/module that is electrically connected to the power electronics circuitry 227. Additionally or alternatively, the power adaptor 210 may comprise, and may use, a processor 550 and a memory 570 to perform one or more of the operations shown in FIG. 4B. For example, the processor 550 and the memory 570 may be a part of a box/module that includes the power adaptor 210, or may be in a separate box/module that is electrically connected to the power adaptor 210.

Systems, methods, and apparatuses for delivering electric power and/or data via indoor telecommunications network infrastructure 215 according to embodiments of the present inventive concepts may provide a number of advantages. As an example, the system 200 illustrated in FIG. 2A may be used to deliver electric power to outdoor equipment 230 that provides fixed wireless (e.g., millimeter wave) service at a building 102, or that provides any other telecommunications service into the building 102 and/or adjacent building(s) 102. In some embodiments, the outdoor equipment 230 may be outdoor wireless network equipment 230W (FIG. 2A) comprising an outdoor WiFi/cellular gateway and/or access point that controls repeaters (e.g., customer-installed indoor WiFi/cellular repeaters) or other devices to provide wireless communications service into the building 102 and/or adjacent building(s) 102. Because delivery of electric power and/or data to the outdoor equipment 230 is provided via an outdoor NIA 220, a telecommunications technician does not need to access the inside of the building 102 to connect the outdoor equipment 230 to data and/or electric power. Rather, the technician can perform all connection/installation work from outside of the building 102.

The outdoor NIA 220 may include power electronics circuitry 227 (FIG. 2B), which may be configured to provide a power conversion of input electric power and/or a physical medium change (e.g., a change from coaxial wiring to Category 6 wiring to provide data from one network to another network). For example, the outdoor NIA 220 may convert input AC electric power from electrical connection(s) 217 (FIG. 2B) into output DC electric power for an electrical connection 218 (FIG. 2B). Additionally or alternatively, the outdoor NIA 220 may provide electric power and/or data from the connection(s) 217 to the connection 218, or from a first connection 217-A to a second connection 217-B, where the connection(s) 217 and/or the connection 218 may comprise connectors for different respective physical communications media 216 (FIG. 2C).

The power electronics circuitry 227 may be an original component of the outdoor NIA 220 or may be a retrofit component (e.g., a box/module) that is added to the outdoor NIA 220. Moreover, the power electronics circuitry 227 may be configured to convert/deliver only electric power or to transmit/receive data in addition to converting/delivering electric power.

Accordingly, whereas a conventional NID on a building provides telephony access but typically lacks electric power from inside the building, embodiments of the present inventive concepts may allow a customer to self-install a device, such as a power adaptor 210 (FIG. 2A), that is configured to provide reverse power feeding via the indoor infrastructure 215 from inside the building 102 to outside the building 102. As an example, the customer may plug the power adaptor 210 into a power outlet 205 (FIG. 2A) and may electrically connect the power adaptor 210 to a telephone network that is connected to the outdoor NIA 220 (e.g., by plugging a twisted-pair telephone cable from the power adaptor 210 into an existing telephone jack in the building 102). The outdoor NIA 220 can then provide electric power to the outdoor equipment 230, without requiring a telecommunications industry technician to enter the building 102.

For example, the power adaptor 210 can (i) take power from an indoor power grid of the building 102, (ii) perform a power conversion on the power from the indoor grid, and then (iii) insert the converted power onto a telephone cable that extends from the power adaptor 210 and connects (e.g., via a telephone wall jack) to an indoor telephone wiring network. The inserted power is delivered over that network to the outdoor NIA 220. Additionally or alternatively, the power adaptor 210 can be coupled to an indoor coaxial network via a coaxial cable that connects to a coaxial wall jack. Accordingly, the power adaptor 210 can deliver power to the outdoor NIA 220 via, for example, an indoor telephone wiring network and/or an indoor coaxial network. Embodiments of the present inventive concepts can thus advantageously facilitate cost-effective and time-independent installation of communications equipment/service (e.g., fixed wireless service provided by a fixed wireless node 150 (FIG. 1)) for the building 102.

The present inventive concepts have been described above with reference to the accompanying drawings. The present inventive concepts are not limited to the illustrated embodiments. Rather, these embodiments are intended to fully and completely disclose the present inventive concepts to those skilled in this art. In the drawings, like numbers refer to like elements throughout. Thicknesses and dimensions of some components may be exaggerated for clarity.

Spatially relative terms, such as “under,” “below,” “lower,” “over,” “upper,” “top,” “bottom,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the example term “under” can encompass both an orientation of over and under. The device may be otherwise oriented (rotated 90 degrees or at other orientations) and the spatially relative descriptors used herein interpreted accordingly.

Herein, the terms “attached,” “connected,” “interconnected,” “contacting,” “mounted,” and the like can mean either direct or indirect attachment or contact between elements, unless stated otherwise.

Well-known functions or constructions may not be described in detail for brevity and/or clarity. As used herein the expression “and/or” includes any and all combinations of one or more of the associated listed items.

The terminology used herein is for the purpose of describing particular embodiments only and is not intended to be limiting of the present inventive concepts. As used herein, the singular forms “a,” “an,” and “the” are intended to include the plural forms as well, unless the context clearly indicates otherwise. It will be further understood that the terms “comprises,” “comprising,” “includes,” and/or “including” when used in this specification, specify the presence of stated features, operations, elements, and/or components, but do not preclude the presence or addition of one or more other features, operations, elements, components, and/or groups thereof.

That which is claimed is:

1. A system that is configured to deliver electric power via an indoor telecommunications network infrastructure that is inside a building, the system comprising:
a power adaptor that is inside the building and is electrically connected to the indoor telecommunications network infrastructure;
an outdoor network interface apparatus that is outside of the building and that is configured to receive input electric power via a wired connection to the indoor telecommunications network infrastructure; and
telecommunications network equipment that is outside of the building and outside of the outdoor network interface apparatus, wherein the outdoor network interface apparatus is further configured to provide output electric power to the telecommunications network equipment.

2. The system of claim 1, wherein the outdoor network interface apparatus is further configured to receive data via the wired connection or via another wired connection to the indoor telecommunications network infrastructure.

3. The system of claim 1, wherein the outdoor network interface apparatus comprises an outdoor Network Interface Device (NID).

4. The system of claim 1, wherein the outdoor network interface apparatus comprises power electronics circuitry that is configured to receive the input electric power via the wired connection.

5. The system of claim 4,
wherein the wired connection comprises a first wired connection,
wherein the telecommunications network equipment comprises wireless network equipment,
wherein the power electronics circuitry is further configured to provide the output electric power to the wireless network equipment via a second wired connection, based on the input electric power, and
wherein the output electric power is different from the input electric power.

6. The system of claim 5,
wherein the indoor telecommunications network infrastructure comprises preexisting telephone, computer-network, or coaxial wiring, or preexisting optical fiber, that is inside the building, and
wherein the wireless network equipment comprises a fixed wireless node.

7. The system of claim 1, wherein the power adaptor is:
plugged into an electrical power outlet that is inside the building; and
connected to a jack of the indoor telecommunications network infrastructure.

8. An outdoor network interface apparatus that is configured to receive input electric power via a wired connection to an indoor telecommunications network infrastructure that is inside a building, and to provide output electric power to telecommunications network equipment that is outside of the building and outside of the outdoor network interface apparatus.

9. The outdoor network interface apparatus of claim 8, wherein the outdoor network interface apparatus is further configured to receive data via the wired connection or via another wired connection to the indoor telecommunications network infrastructure.

10. The outdoor network interface apparatus of claim 8, wherein the outdoor network interface apparatus comprises an outdoor Network Interface Device (NID).

11. The outdoor network interface apparatus of claim 8, comprising power-conversion circuitry that is configured to:
receive the input electric power via the wired connection, wherein the wired connection comprises a first wired connection;
convert the input electric power into the output electric power, wherein the output electric power is different from the input electric power; and
provide the output electric power to the telecommunications network equipment via a second wired connection.

12. The outdoor network interface apparatus of claim 8,
wherein the wired connection comprises a first electrical connection to a first physical communications medium of the indoor telecommunications network infrastructure, and
wherein the outdoor network interface apparatus comprises a second electrical connection to a second physical communications medium of the indoor telecommunications network infrastructure.

13. The outdoor network interface apparatus of claim 12,
wherein the first electrical connection comprises a first cable jack, cable port, or wire terminal, and
wherein the second electrical connection comprises a second cable jack, cable port, or wire terminal.

14. The outdoor network interface apparatus of claim 12, wherein the outdoor network interface apparatus further comprises power-conversion circuitry that is electrically connected to the first electrical connection, the second electrical connection, or both the first electrical connection and the second electrical connection.

8. door network interface apparatus of claim 8,
wherein the telecommunications network equipment comprises wireless network equipment that is configured to provide wireless communications service into the building, and
wherein the outdoor network interface apparatus comprises power electronics circuitry that is configured to provide the output electric power to the wireless network equipment based on the input electric power.

16. The outdoor network interface apparatus of claim 8, wherein the indoor telecommunications network infrastructure comprises:
preexisting telephone, computer-network, or coaxial wiring, or preexisting optical fiber, that is inside the building and that is electrically connected to a power converter that is inside the building.

17. A method of delivering electric power via an indoor telecommunications network infrastructure that is inside a building, the method comprising:
receiving input electric power at an outdoor network interface apparatus that is outside of the building via a wired connection to the indoor telecommunications network infrastructure; and
providing output electric power to telecommunications network equipment that is outside of the building and outside of the outdoor network interface apparatus, based on the input electric power.

18. The method of claim 17, further comprising:
receiving, via the wired connection or via another wired connection to the indoor telecommunications network infrastructure, data at the outdoor network interface apparatus.

19. The method of claim 17, further comprising:
transmitting a signal from the outdoor network interface apparatus to the indoor telecommunications network infrastructure, to request the input electric power.

20. The method of claim 17, further comprising:
providing the input electric power to the indoor telecommunications network infrastructure via a power adaptor that is inside the building.
